(19) United States
(12) Patent Application Publication
(10) Pub. No.: US 2008/0107394 A1
(43) Pub. Date: May 8, 2008

(54) PLAYBACK DEVICE CAPABLE OF ESTABLISHING A PROGRAM AT A STANDBY MODE AND METHOD THEREOF

(76) Inventor: Chang-Hung Lee, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/930,146

(22) Filed: Oct. 31, 2007

(30) Foreign Application Priority Data
Nov. 7, 2006 (TW) 095141147

(51) Int. Cl. H04N 5/93

(52) U.S. Cl. 386/83

(57) ABSTRACT

A method for establishing a program of a playback device includes: (a) setting a predetermined time of the playback device; (b) running a channel scan for a signal source at a standby mode of the playback device according to the predetermined time set in step (a); and (c) establishing the program corresponding to the signal source according to the channel scan in step (b).

### BACKGROUND OF THE INVENTION

1. Field of the Invention

The present invention relates to a playback device capable of establishing a program and a method thereof, and more particularly, to a playback device capable of establishing a program at a standby mode and a method thereof.

2. Description of the Prior Art

AV signals are conventionally stored in analog format. However, due to disadvantages of conventional analog recording media (such as difficulties in long-term storage, poor image quality after repeated use of video tape, limited recording time, and etc.), digital recording devices rise to replace the conventional analog recorders. Digital recording devices such as digital video recorders (DVR) and digital camcorders are going to be popular. However, it is necessary to scan frequencies of channels from a signal source so as to build a program, such as a TV channel program, corresponding to the signal source when using the digital video recorder for the first time. Otherwise the corresponding TV channel can not be searched. Scanning for channels takes a long time, and is extremely inconvenient when users want to operate DVRs immediately.

### SUMMARY OF THE INVENTION

It is therefore a primary objective of the claimed invention to provide a playback device capable of establishing a program at a standby mode and a method thereof for solving the above-mentioned problem.

According to the claimed invention, a method for establishing a program of a playback device includes: (a) setting a predetermined time at a standby mode of the playback device; (b) running a channel scan for a signal source according to the predetermined time set in step (a); and (c) establishing the program corresponding to the signal source according to the channel scan in step (b).

According to the claimed invention, a playback device includes a tuner for running a channel scan for a signal source, a timer for counting time, and a control unit for controlling the tuner to run the channel scan and establishing the program corresponding to the signal source when the playback device is at a standby mode and time counted by the timer corresponds to a predetermined time.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a playback device according to a preferred embodiment of the present invention.

FIG. 2 is a flowchart of establishing a program corresponding to a signal source of the playback device according to the preferred embodiment of the present invention.

### DETAILED DESCRIPTION

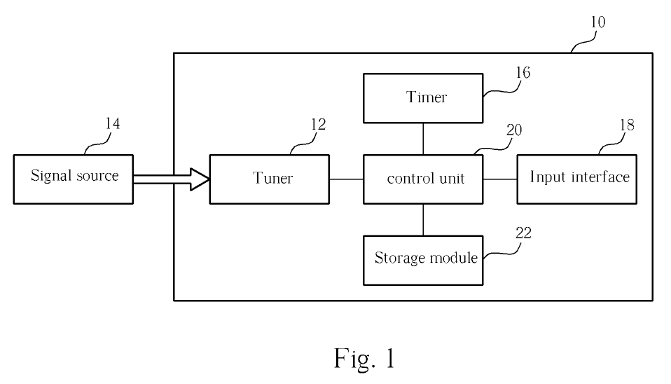

Please refer to FIG. 1. FIG. 1 is a functional block diagram of a playback device 10 capable of establishing a program at a standby mode according to a preferred embodiment of the present invention. The playback device can be a recorder, such as a digital video recorder (DVR), or a television. In this invention, “the standby mode” is defined as that the playback device 10 operates the function irrelevant with the signal source 14. The playback device 10 includes a tuner 12 for running a channel scan (i.e. scanning frequencies of channels from a signal source 14) so as to build a program corresponding to the signal source 14. The signal source 14, for example, is a cable TV signal source or a wireless TV signal source. The playback device 10 further includes a timer 16 for counting time, an input interface 18 for providing users to set a predetermined time at the standby mode of the playback device, a control unit 20 for controlling the tuner 12 to run the channel scan and establishing the program corresponding to the signal source 14 when the playback device 10 is at the standby mode and time counted by the timer 16 corresponds to the predetermined time input by the input interface 18, and a storage module 22 for storing the program corresponding to the signal source 14.

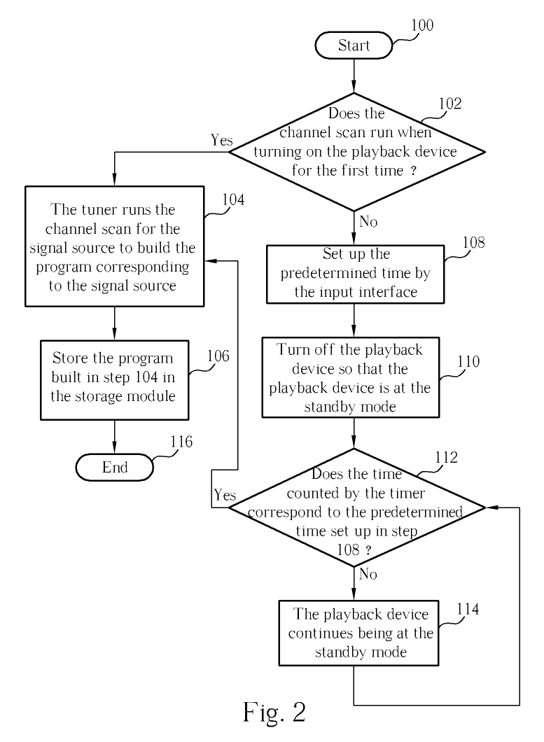

Please refer to FIG. 2. FIG. 2 is a flowchart of establishing the program corresponding to the signal source 14 of the playback device 10 according to the preferred embodiment of the present invention. The method includes following steps:

Step 100: Start.

Step 102: Determine whether to run the channel scan when turning on the playback device 10 for the first time. If yes, go to step 104; if no, go to step 108.

Step 104: The tuner 12 runs the channel scan for the signal source 14 to build the program corresponding to the signal source 14.

Step 106: Store the program built in step 104 in the storage module 22.

Step 108: Set up the predetermined time by the input interface 18.

Step 110: Turn off the playback device 10 so that the playback device 10 is at the standby mode.

Step 112: Determine whether the time counted by the timer 16 corresponds to the predetermined time set up in step 108. If yes, go to step 104; if no, go to step 114.

Step 114: The playback device 10 continues being at the standby mode.

Step 116: End.

The detailed description is introduced as follows. The user can determine whether the channel scan is run when turning on the playback device 10 for the first time. If the user can wait for the scanning procedure, he/she can choose to run the channel scan when the playback device 10 connected to the signal source 14 is turned on for the first time. Then the tuner 12 scans frequencies of channels from the signal source 14, and the control unit 20 bases on the channel scan to build the program corresponding to the signal source 14, such as the TV channel program. The program is stored in the storage module 22. If the user does not want to wait for the scanning procedure, he/she can choose to run the channel scan when the playback device 10 connected to the signal source 14 is at the standby mode. “The standby mode” means the playback device 10 operates the function irrelevant with the signal source 14, e.g. the playback device 10 plays audiovisual data stored in DVD or VCD.

The user can set up the predetermined time at the standby mode by the input interface 18. For example, the user can set the playback device 10 to run the channel scan automatically at a specific time point, such as 2 A.M., or after a predetermined time interval later than turning off the playback device 10. The predetermined time at the standby mode can also be preset by manufacturer. In this embodiment, the playback device 10 is turned off but electrically connected to power to be ready for the next operation. Till the time counted by the timer 16 corresponds to the predetermined time set up in step 108, the control unit commands the tuner 12 to run the channel scan for the signal source 14 automatically, and builds the program corresponding to the signal source 14. Then the program is stored in the storage module 22. On the other hand, when the time counted by the timer 16 does not meet the predetermined time set up in step 108, the playback device 10 continues being at the standby mode.

In contrast to the prior art, the present invention provides a playback device and a method for executing an operation of scanning frequencies of channels automatically when the playback device is at the standby mode. It can save waiting for the scanning procedure when the playback device is turned on for the first time and is convenient to users to execute the scanning procedure automatically when the playback device is at the standby mode.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for establishing a program of a playback device comprising:
(a) setting a predetermined time at a standby mode of the playback device;
(b) running a channel scan for a signal source according to the predetermined time in step (a); and
(c) establishing the program corresponding to the signal source according to the channel scan in step (b).

2. The method of claim 1 wherein step (b) comprises the playback device runs the channel scan for a cable TV signal at the standby mode according to the predetermined time set in step (a).

3. The method of claim 1 wherein step (b) comprises the playback device runs the channel scan for a wireless TV signal at the standby mode according to the predetermined time set in step (a).

4. A playback device capable of establishing a program at a standby mode, the playback device comprising:
a tuner for running a channel scan for a signal source;
a timer for counting time; and
a control unit for controlling the tuner to run the channel scan and establishing the program corresponding to the signal source when the playback device is at the standby mode and time counted by the timer corresponds to a predetermined time.

5. The playback device of claim 4 wherein the tuner is for running the channel scan for a cable TV signal.

6. The playback device of claim 4 wherein the tuner is for running the channel scan for a wireless TV signal.

7. The playback device of claim 4 further comprising an input interface for setting the predetermined time.

8. The playback device of claim 4 further comprising a storage module for storing the program corresponding to the signal source.
